(19) United States
(12) Patent Application Publication
(10) Pub. No.: US 2009/0115756 A1
(43) Pub. Date: May 7, 2009

(54) Matrix phosphor cold cathode display employing ion activated phosphors

(75) Inventors: Denis Krusos, Melville, NY (US); Anthony Campisi, Melville, NY (US)

Correspondence Address: The Plevy Law Firm;Arthur L. Plevy, 10 Rutgers Place, Trenton, NJ, 08618, US

(73) Assignee: CopyTele, Inc., Melville, NY (US)

(21) Appl. No.: 12/152,020

(22) Filed: May 12, 2008

Related U.S. Application Data
(60) Provisional application No. 60/999,783, filed on Oct. 19, 2007.
(60) Provisional application No. 61/000,958, filed on Oct. 30, 2007.

(51) Int. Cl. G09G 5/00

(52) U.S. Cl. 345/207

(57) ABSTRACT

A vacuum flat panel display has a plurality of associated pixels each having a phosphor and nanotubes and a surrounding control frame. When a pixel voltage is negative relative to the frame then a plurality of electrons emitted by the nanotubes are attracted to the frame whereby electrons strike gas atoms in transit to the frame and produce ions and additional electrons; wherein said ions returning to the pixel result in phosphor illumination. The invention is also a process for illuminating a phosphor in a flat panel display comprising: a plurality of associated pixels each having a phosphor and nanotubes; applying a pixel voltage negative relative to a frame; attracting to the frame a plurality of electrons emitted by the nanotubes; whereby electrons strike atoms of a gas in transit to the frame producing ions resulting in phosphor illumination.

### RELATED APPLICATIONS

Co-pending applications entitled “Passive Matrix Phosphor Based Cold Cathode Display”, Ser. No. 60/999,783, filed on Oct. 19, 2007, “Active Matrix Phosphor Cold Cathode Display”, Ser. No. 61/000,958, filed on Oct. 30, 2007, A Matrix Phosphor Cold Cathode Display Employing Secondary Emission, Ser. No. 12/079,658 filed on Mar. 28, 2008 and other pending applications regarding flat panel display technology.

### FIELD OF THE INVENTION

This application is generally related to the field of displays and more particularly to flat panel displays employing phosphor pixels, frame and cold cathode emission sources, and providing excitation of the phosphor by ion bombardment resulting in a simplification of the display construction especially in the electronic configuration of the display and in a cost reduction due to the lower voltages required to operate the display.

### BACKGROUND OF THE INVENTION

Flat panel display (FPD) technology is one of the fastest growing display technologies in to the world. As a result of this growth, a large variety of FPDs exist, which range from very small virtual reality eye tools to large hang-on-the-wall television displays. Copytele, the applicant herein, has many patents and applications relating to such displays.

It is desirable to provide a display device that may be operated in a cold cathode field emission configuration such as nanotubes, edge emitters, etc. and that exhibits a uniform, enhanced and adjustable brightness with good electric field isolation between pixels. Such a device would be particularly useful as a low voltage FPD, incorporating a cold cathode electron emission system, a pixel control system, and phosphor based pixels, with or without memory and active devices such as transistors including those of the thin film construction. It is further desirable to provide a brighter display and, therefore, there is described means for exciting the phosphor by ion bombardment.

### SUMMARY OF THE INVENTION

In one exemplary embodiment, a flat panel display including: a plurality of electrically addressable pixels; a plurality of thin film transistor driver circuits each being electrically coupled to an associated at one of the pixels, respectively; a passivating layer on the thin-film transistor driver circuits and at least partially around the pixels; a conductive frame on the passivating layer; and a plurality of cold cathode emitters and phosphor deposited on top of the pixel material wherein, exciting the conductive frame and addressing one of the pixels using the associated driver circuit causes the cold cathode emitters to emit electrons which electrons go to the frame; wherein some emitted electrons strike gas atoms enroute to the frame producing ions and additional electrons. The ions return to the pixel causing the phosphor to illuminate and additional electrons to be released.

In one exemplary embodiment, there is provided a thin, phosphor-based active TFT matrix flat panel display. Adjacent each pixel in the matrix is a control conductive frame. The control frame surrounds pixels, which pixels consist of a conductive layer coated with a phosphor (Red, Green or Blue) and nanotubes. The frame consists of a conductive material (chrome, aluminum and so on). The frame and pixel voltages are controlled by a TFT circuit to cause electrons emitted by the nanotubes to go to the frame. Some electrons strike gas atoms en route to the frame producing ions and additional electrons. The ions return to the pixel causing the phosphor to illuminate and additional electrons to be released.

### BRIEF DESCRIPTION OF THE DRAWINGS

It is to be understood that the accompanying drawings are solely for purposes of illustrating the concepts of the invention and are not drawn to scale. The embodiments shown in the accompanying drawings, and described in the accompanying detailed description, are to be used as illustrative embodiments and should not be construed as the only manner of practicing the invention. Also, the same reference numerals, possibly supplemented with reference characters where appropriate, have been used to identify similar elements.

FIG. 1 illustrates a circuit for driving the pixels according to an aspect of the present invention.

FIG. 2 illustrates a timing diagram depicting circuit driver operation.

FIG. 3 illustrates an exemplary display device according to an aspect of the present invention.

FIG. 4 illustrates a control frame around each pixel and having a DC, AC or pulsed voltage applied according to an aspect of the present invention.

FIG. 4a illustrates a control frame according to another aspect of the present invention.

FIG. 5 illustrates a top view of a control frame according to another aspect of the present invention.

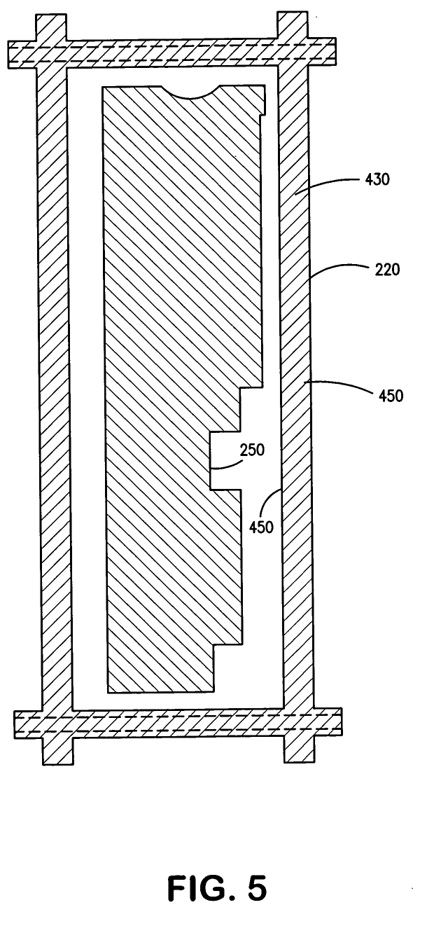

### DETAILED DESCRIPTION OF THE INVENTION

It is to be understood that the figures and descriptions of the present invention have been simplified to illustrate elements that are relevant for a clear understanding of the present invention, while eliminating, for purpose of clarity, many other elements found in typical display (e.g. FPD) systems and methods of making and using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. Furthermore, while the present invention has been described with reference to the illustrative embodiments, this description is not intended to be construed in a limiting sense. Various modifications of the illustrative embodiments, as well as other embodiments of the invention, will be apparent to those skilled in the art on reference to this description.

Before embarking on a more detailed discussion, it is noted that there are other passive matrix displays and active matrix displays that are used in laptop and notebook computers. In a passive matrix display, there is a matrix of solid-state elements in which each element or pixel is selected by applying a potential voltage to a corresponding row and column line that forms the matrix. In an active matrix display, each pixel is further controlled by at least one transistor and a capacitor that is also selected by applying a potential to a corresponding row and column line. Part of the invention lies in the recognition that a TFT-based display device with a control frame disposed thereon exhibits enhanced performance and effects useful for display devices. Electron emission sources may be used with such a frame to form a cold cathode configuration, such as one including edge emitters, or nanotube emitters, and or other cold cathode electron emitters. Cold cathode emitters may also be used which are not associated with the frame. This has been disclosed in pending applications (see Related Applications). Here there is described increased secondary emission of an FED display for enhancing illumination of the display.

According to an aspect of the present invention, a pixel matrix control system having a control frame around each pixel associated with a thin film transistor (TFT) circuit of a display device is used to provide a display characterized as having a good uniformity, adjustable brightness, and a good electric field isolation between pixels, regardless of the type of electron source used. For purposes of completeness, a TFT is a type of field effect transistor made by depositing thin films for the metallic contacts, semiconductor active layer, and dielectric layer. TFT's are widely used in liquid crystal display (LCD) FPDs.

The control frame surrounds the pixel and hence, the TFT, and is disposed in an inactive area between the pixels (e.g. on an insulating substrate over the respective columns and rows). The pixels have a thin layer of a conductive material on a metal pad deposited at the pixel location. Carbon nanotubes (CNT) and Phosphor are deposited on top of the pixel area. During operation electrons emitted by the nanotubes go to the frame. Some electrons strike gas atoms producing ions and more electrons. The ions return to the frame causing the pixel to illuminate and additional electrons to be released. When the ions strike the pixel covered with phosphor and nanotubes more electrons are released.

According to an aspect of the present invention, the control frame includes a plurality of conductors, typically arranged in a matrix having parallel horizontal conductors and parallel vertical conductors. Each pixel is bounded by the intersection of vertical and horizontal conductors, such that the conductors surround the corresponding pixels to the right, left, top, and bottom in a matrix fashion. One or more conductive pixel pads are electrically connected to the control frame. The control frame may be fabricated of a metal including, for example, chrome, molybdenum, aluminum, and/or combinations thereof.

According to an aspect of the present invention, the control frame can be formed using standard lithography, deposition and etching techniques.

In one exemplary configuration, conductors parallel to columns and rows are electrically connected together, and a voltage is applied thereto. In another exemplary configuration, conductors parallel to columns are electrically connected together, and have a voltage applied thereto. Conductors parallel to the rows are also connected together, with a voltage applied thereto. In yet another exemplary configuration, a voltage is only applied to one of the parallel rows or columns of conductors.

According to an aspect of the present invention, a vacuum FPD or a FPD containing a noble gas in the hollow of the display, incorporating a TFT circuit may be provided. Associated with each pixel element is a TFT circuit that is used to selectively address that pixel element in the display. In one configuration the TFT circuit includes first and second active device electrically cascaded, and a capacitor coupled to an output of the first device and an input of the second device.

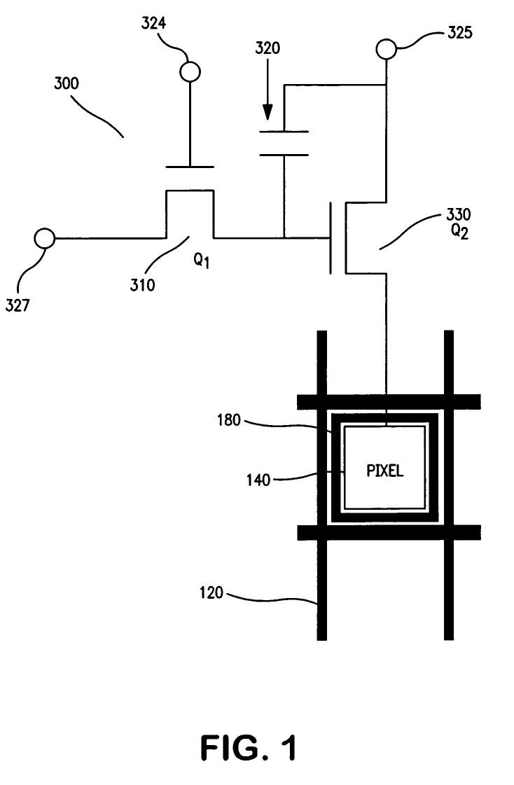

Referring to FIG. 1, there is shown a TFT circuit 300 for driving a pixel 140 according to this invention, the TFT substrate of the display consists of the desired number of pixels each having the configuration shown in FIG. 1. The pixels consist of conductive layer coated with phosphor (red, green, or blue) and nanotubes 180. The Frame 120 consists of a conductive material (for ex. chrome, aluminum, etc.). The nanotubes can be deposited first on the phosphor or they can be mixed and then deposited.

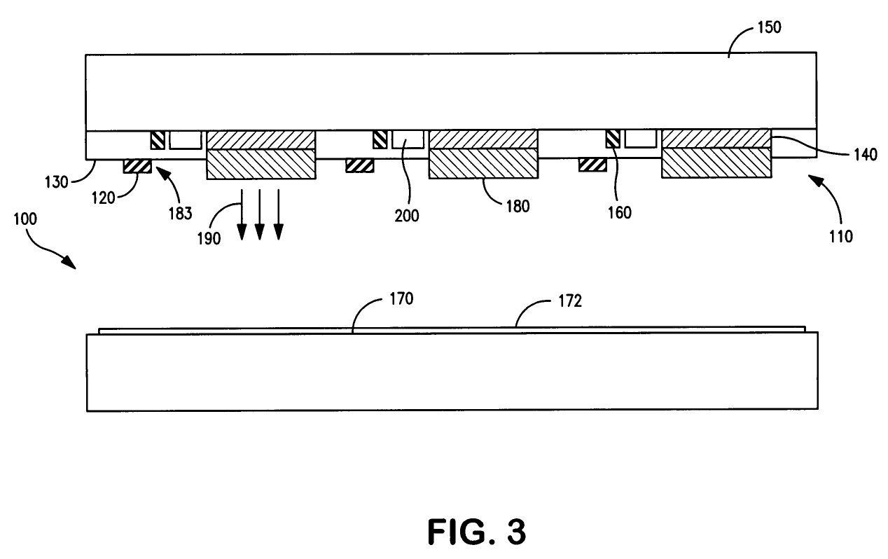

According to an aspect of the present invention, control of one or more of the TFTs associated with the display device of the present invention may be accomplished using an active matrix location 300 as shown in FIG. 1. The circuit comprising the active matrix location 300 includes transistors TFT 330 and TFT 310 and capacitor 320 electrically interconnect to a pixel 140, e.g., pad 140, FIGS. 1 and 3.

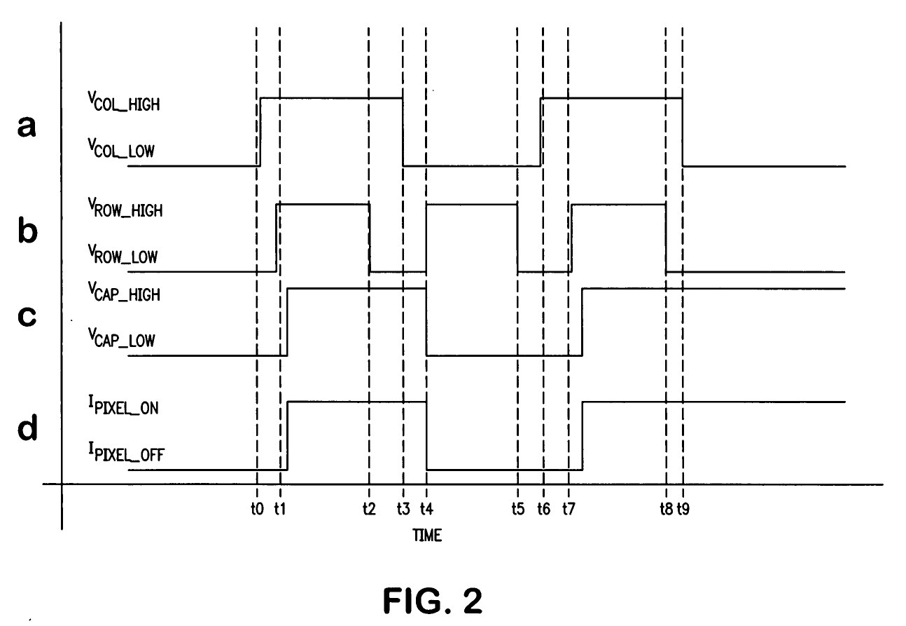

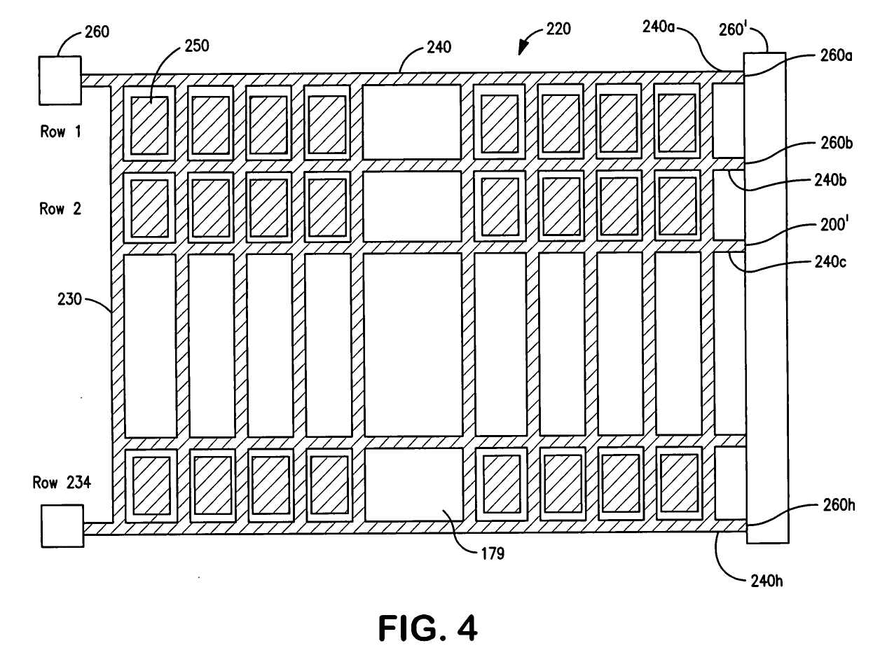

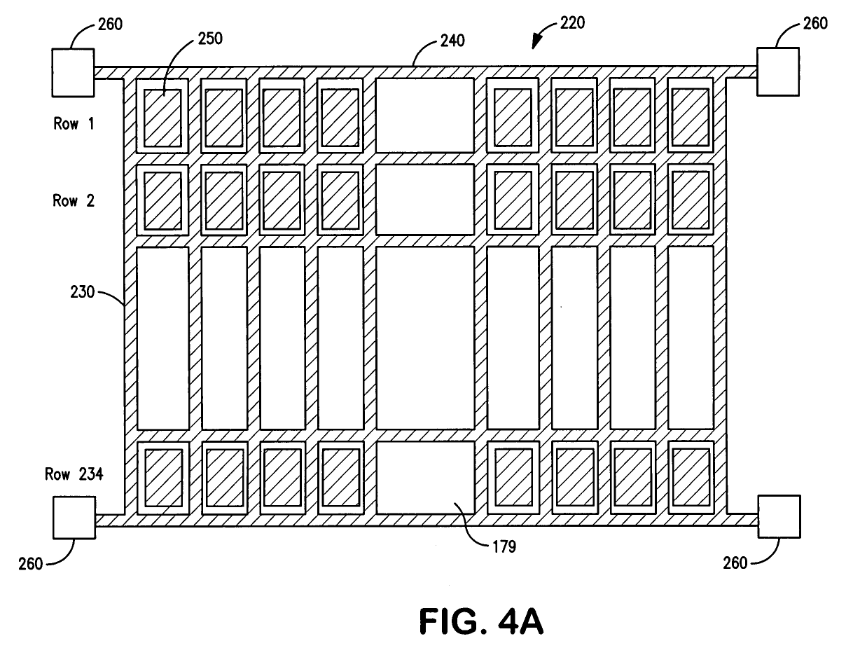

The TFT substrate of the display consists of the desired number of pixels 140 each having the active matrix location 300 configuration as shown in FIG. 1. The pixels 140 are comprised of conductive layer coated with a phosphor (RGB) and nanotubes 180. Referring to FIG. 1 and FIG. 2 at time t₁ when a row driver output 324 is selected (e.g., V_{row-high}=15V in FIG. 4b) TFT 310 turns “on” enabling new column data 327 (e.g., V_{col-high}=15V in FIG. 4a) to be stored in capacitor 320 at time t₁ (e.g., Vₚᵢₓₑₗ₋ₒₙ=15V in FIG. 2d). If row 324 is at zero volts (e.g., V_{row-low}=0V at t₀, t₃, t₆, t₉, in FIG. 2b) the particular active matrix location 300 is not selected and new column data from the column driver output 327 cannot be written to capacitor 320. It should be noted that the row 324 shown at a potential of V_{row-high}=15V may be any other voltage sufficient enough to turn “on” transistor 310. It should also be noted that row 324 shown at a potential V_{row-low} may be any other voltage sufficient to turn “off” transistor 310. The voltages used are a function of the minimum voltage requirement of the drivers (not shown) and the TFT 310 used.

When the data stored at location capacitor 320, is represented by greater than the threshold voltage of transistor 330 this turns “on” transistor 330 allowing current to flow through transistor 330. When the data stored represented by the voltage at capacitor 320 is less than the threshold voltage of transistor 330 the, transistor 330 is cut “off’ and current cannot flow through transistor 330. When transistor 330 is in an “on” state this applies ground or any voltage negative relative to the frame 120 voltage to the pixel pad 140. The frame 120 has a positive voltage relative to the pixel pad.

Since the pixel pad 140 voltage is negative relative to the frame 120 (Vₚᵢₓₑₗ less positive than V_{frame}) the electrons emitted by the nanotubes (see, FIG. 1) are attracted to the frame 120. Some electrons strike gas atoms in transit to the frame 120 producing ions and additional electrons. The ions will return to the pixel 140 causing the phosphor 180 to illuminate and additional electrons to be released.

The column driver output 327, which output voltage represents the data to be displayed is connected to transistor 310. The row driver output 324 is connected to the gate of transistor 310. The output of transistor 310 is connected to the gate transistor 330. The output of transistor 330 is connected to pixel 140. When the data as represented by a voltage is in a low state (e.g., V_{co}_{_{—}}_{low}=0V at t₅, in FIG. 4a), transistor 330 does not conduct and there is no pixel 140 current since no ions are attracted to the pixel 140 (e.g., Vₚᵢₓₑₗ_{_{—}}_{OFF}=0V at t₅, in FIG. 4d). When the column driver output 327 is high (e.g., V_{col-high}=15V in FIG. 4a) transistor 330 conducts and ions are attracted to the pixel 140 and the phosphor 180 illuminates.

TFT 330 acts as a switch which is operated at low voltage thereby eliminating the need for high voltage drivers and reducing the cost of the display. In addition, since all voltages (column 327, row 324, frame 120 and anode 325) are positive or at ground, the insulating layers are not required to sustain high voltage gradients and are considerably less likely to breakdown. This invention may be implemented with displays, which use noble gases and with displays which do not use noble gases. Essentially the invention may be used with any display which uses a phosphor to produce an image.

FIG. 3 illustrates a schematic cross-sectional view of a TFT anode based FPD 100 according to one aspect of the present invention. In the exemplary embodiment, display 100 is composed of an assembly 110 that includes an anode and that employs TFT circuitry (as shown in FIG. 1) and a control frame structure 120 is disposed on an anode passivation layer 130. The control frame substantially surrounds and is adjacent to each of the pixel element. In the illustrated embodiment, the pixel metal 140 attracts ions as explained above. Those of ordinary skill in the art may recognize that other configurations with cold cathode emitter in various other locations are possible.

Assembly 110 of FIG. 3 includes a plurality of conductive pixel pads 140 fabricated in a matrix of substantially parallel rows and columns on a substrate 150 using conventional fabrication methods. Each pixel pad (FIG. 1) is covered with a phosphor and carbon nanotubes 180. Substrate 150 may be formed of a transparent material, such as glass, or a flexible material (such as a plastic with no internal outgassing during sealing and vacuumization processing), but may be opaque. Substrate 170, which serves to confine the FPD housing in an evacuated or an inert or noble gas environment may also be made of a transparent (or at least translucent) material, such as glass or flexible material, but alternatively may be opaque. In the exemplary embodiment depicted in FIG. 3, substrate 170 has a layer of metal (ML) 172 secured on or otherwise formed on the surface. The ML layer 172 as shown and configured relative to assembly 110. The ML layer 172 is transparent and may be ITO or some other metal. The substrates 150 and 170 are bonded or sealed at the peripheries to form an enclosed hollow which may be filled with an inert gas, a vacuum or a noble gas. Conductive pixel pads 140 may be composed of a transparent conductive material, such as ITO (Indium Titanium Oxide) or a non-transparent conductor such as Chrome (CR), Moly Chrome (MoCr) or aluminum.

In any event, deposited on each conductive pixel pad 140 is a phosphor layer and nanotubes 180. Each phosphor layer(s) is selected from materials that emit light 190 (FIG. 3) of a specific color, wavelength, or range of wavelengths. In a conventional RGB display, phosphor layer 180 is selected from materials that produce red light, green light or blue light when struck by electrons. In the illustrated embodiment, light (i.e. photons) is emitted in the direction of substrate 170 for viewing. If the pixel metal is of a transparent (or translucent) material (such as ITO) rather than opaque, light emissions 190 would be transmitted in both the directions of substrates 150 and 170 (rather than being reflected via the pixel metal to substrate 170 only, for example).

Incorporated in the TFT circuit (FIG. 1) are conductive pixel column and row addressing lines associated with each of the corresponding conductive pixel pads 140. The pixel row and column addressing lines may be substantially perpendicular to one another. Such a matrix organization of conductive pixel pads and phosphor layers allows for X-Y addressing each of the individual pixel elements in the display as will be understood by those possessing an ordinary skill in the pertinent arts.

Associated with each conductive pixel pad 140/phosphor layer 180 pixel is a TFT circuit 200 (FIG. 3) (300 of FIG. 1) that operates to apply an operating voltage proportional to the data to the associated conductive pixel pad 140/phosphor layer 180 pixel element. TFT circuit 200 operates to apply either a first voltage to bias an associated pixel element to maintain it in an “off” state or a second voltage to bias the associated pixel element to maintain it in an “on” state as required by the data, or any intermediate state as described in FIG. 1.

TFT circuitry 200 biasing conductive pixel pad 140 provides for dual functions of addressing pixel elements and maintaining the pixel elements in a condition to attract ions for a desired time period, i.e., time-frame or sub-periods of time-frame.

Referring now also to FIG. 4 there is shown a plan view of a control frame 220 suitable for use as control frame 120 of FIG. 1. Control frame 220 includes a plurality of conductors arranged in a rectangular matrix having parallel vertical conductive lines 230 and parallel horizontal conductive lines 240, respectively. Each pixel 250 (e.g. pad 140 and phosphor 180 of FIG. 1) is bounded by vertical and horizontal conductors or lines 230, 240, such that the conductors substantially surround each pixel 250 to the right, left, top, and bottom. One or more conductive pads 260 or conductive bars electrically connect conductive frame 220 to a conventional power source. In the illustrated embodiment of FIG. 2, four conductive pads 260 are coupled to the conductive lines 230, 240 of frame 220. In an exemplary embodiment, each pad 260 is around 100×200 micrometers (microns) in size.

FIG. 4a shows another exemplary configuration of a control frame structure similar to that of FIG. 2 (wherein like reference numerals are used to indicate like parts), but wherein two of the pads 260 of FIG. 2 are replaced by a single conductive bar or bus 260′. The conductive bar 260′ is coupled to each of the parallel horizontal conductive lines 240ₐ, 240_{b}, 240_{c}, . . . 240ₙ at corresponding positions 260ₐ, 260_{b}, 260_{c}, . . . 260ₙ along the bar. In the illustrated configuration, the row lines are substantially identical to one another and interconnect to the bar at uniform spacings along the length of the bar. This configuration provides for an equipotential frame configuration with minimal voltage drops as a function of frame position.

In the illustrated embodiment control frame 220 (or 220′) is formed as a metal layer above the final passivation layer (e.g. 130, FIG. 1). Pads 260 and metal lines that provide the control frame structure 220 remain free from passivation in the illustrated embodiment. In an exemplary configuration, the control frame metal layer has a thickness of less than about 1 micron (um), and a width may be used depending on particular design criteria.

According to one aspect of the present invention, nanostructures are provided upon the pixels 250 which are coated with a phosphor. The nanostructures may take the form of carbon nanotubes, for example. The nanostructures may take the form of SWNTs or MWNTs. The nanostructures may be applied to the control frame using any conventional methodology, such as spraying, growth, or printing, for example. Other cold cathode emitters may be used.

While the vertical line conductors 230 and horizontal line conductors 240 frame each pixel 250 above the plane of the pixels 250 in the illustrated embodiment (see, e.g. FIG. 1), other configurations are contemplated, such as where the conductors are disposed in the same plane as the pixels. Further yet, conductors 230, 240 may be connected in a number of configurations. For example, in one configuration, all horizontal and vertical conductors are joined together as shown in FIG. 2 and a voltage is applied to the entire control frame configuration. In another configuration, all horizontal conductors 240 are joined and separately all vertical conductors 230 are joined. In this connection configuration the horizontal conductors 240 and vertical conductors 230 are not electrically interconnected. Thus, a voltage may be applied to the horizontal conductor array, and a separate voltage may be applied to the vertical conductor array. Other configurations are also contemplated, including for example: a configuration of all horizontal conductors only, or a configuration of all vertical conductors only. For example, the control frame may include only metal lines parallel to the columns or only metal lines parallel to the rows.

By negatively biasing the pixel voltage (V_{PIXEL}) relative to the voltage of the frame, electrons emitted by the nanotubes go to the frame. Some electrons strike gas atoms en route to the frame producing ions and additional electrons. The ions return to the pixel causing the phosphor to illuminate and additional electrons to be released. The wavelength of the emitted light depends upon the phosphor (Red, Green, Blue).

According to an aspect of the present invention, control of one or more of the TFTs associated with the display device of the present invention may be accomplished using the circuit 300 of FIG. 1. Circuit 300 includes first and second transistors 310, 330 and capacitor 320 electrically interconnect with a pixel, e.g. pad 140, FIG. 1.

In general, the voltage used to select the row (V_{ROW}) is equal to the fully “on” voltage of the column (Vc). The row voltage in this case causes the pass transistor 310 to conduct. The resistance of pass transistor 310, capacitor 320 and the write time of each selected pixel row determines the voltage at the gate of transistor 330, as compared to Vc. V_{ANODE} 325 the power supply voltage, and may be on the order of about 10-40 volts.

Referring to FIG. 4, the conductive part of frame 220 may be widened (e.g. by about 4 um) and an insulating layer 450 (e.g. SiN) provided at each edge for preventing electrical short circuits from the frame to the pixels, and to encapsulate the frame edge which is associated with high field intensity. Accordingly, the exposed part 430 of the frame may have a width of about 12-15 um.

Emissive displays using phosphor to emit light in order to display an image including: a source of electrons, pixels including phosphor on a conductive surface, and a conductive layer capable of extracting electrons from the display surfaces. In a cold cathode display, as described herein, the source of electrons may be nanotubes, edge emitters, tips, and so on. The phosphor and nanotubes are placed on the pixels and light is emitted from the phosphor when ions emitted strike the phosphor. The amplitude of the illumination is a linear function of the power consumed by the phosphor. The power is a linear function of the number of ions arriving at the phosphor for a given voltage.

Therefore, any means to maximize the electron flow from the cold cathode to the phosphor will optimize the illumination and performance of the display.

By varying the voltage applied to ML 172 (FIG. 3) and optimizing the effect of the field generated by the ML voltage, depending on the physical configuration of the display, will result in an increase of the electron flow from the cold cathodes, resulting in increased brightness and optimum display performance.

The DC, AC or pulsed voltage on ML for optimum performance is a function of the geometry of the components in the display and must be determined independently for the physical structure of the particular display.

The introduction of a noble gas, such as argon and/or mixtures of noble or ionizable gases at low pressure into the display, and applying a DC, AC or pulsed voltage to ML to create a plasma and coating the frame and pixel metal with an insulator creating a sheath results in multiplication of the current produced by the cold cathode electron emitting source, such as nanotubes, edge emitters, etc. by order of magnitude while the applied voltage is virtually constant. The coating with the insulator causes increased secondary emission as described while the creation of the sheath in the plasma cause electron multiplication and thus increases the brightness of the display without an increase in the cold cathode voltage applied. Since the photons (light level) emitted by the phosphor is a linear function of the power then the brightness, at a constant voltage on the pixel, is a linear function of the current. Since the current increases order of magnitude then the brightness will increase at the same rate. The creation of the plasma is a function of the DC, AC or pulsed voltage applied to the ML.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, the control frame described previously may be used with any display which uses electrons or charged particles to form an image. As discussed above, it is also understood that the present invention may be applied to flexible displays in order to form an image thereon.

It is expressly intended that all combinations of those elements that perform substantially the same function in substantially the same way to achieve the same results are within the scope of the invention. Substitutions of elements from one described embodiment to another are also fully intended and contemplated.

What is claimed is:

1. A flat panel display comprising:
i. a plurality of electric addressable pixels, each having a phosphor and cold cathode emitters thereon.
ii. a plurality of thin-film transistor (TFT) driver circuits each being electrically coupled to an associated at least one of said pixels, respectively;
iii. a passivating layer on said thin-film transistor driver circuits and at least partially around said pixels;
iv. a conductive frame on said passivating layer, said frame bounding said pixel; and
vi. means for exciting said conductive frame and addressing one of said pixels using said associated driver circuit to cause said cold cathode emitters to emit electrons that are attracted to said frame and which electrons produce ions which are attracted to said pixel causing said phosphor to illuminate.

2. The display of claim 1, wherein said cold cathode emitters are carbon nanotubes.

3. The display of claim 1 including a substrate supporting said pixels, TFT driver circuits, said passivating layer and frame and a second substrate sealed about the periphery to said first substrate to form a display housing having an internal hollow.

4. The display according to claim 3, wherein said hollow is filled with an ionizable gas or mixture.

5. The display of claim 1, wherein said conductive frame comprises a plurality of parallel columns of conductors.

6. The display of claim 1, wherein said conductive frame comprises a matrix row and column conductors defining a plurality of cells each associated with one of said pixels.

7. The display of claim 1, wherein:
i. each said pixel includes a conductive pad ; and
ii. said driver circuit comprises at least one transistor coupled to said pixel.

8. The display of claim 1, wherein:
iii. each said pixel includes a conductive pad; and
iii. said driver circuit comprises a first transistor coupled to said conductive pad, and a second transistor and capacitor coupled to a gate of said first transistor.

9. A display comprising:
v. a substrate;
vi. a plurality of electrically addressable pixels supported on said substrate;
vii. a conductive frame supported on said substrate; and,
viii. a plurality of cold cathode emitters positioned on said pixel and operative to emit electrons when an associated pixel is addressed, a phosphor on said pixel and operative to emit light when energized;
ix. means for exciting said conductive frame and addressing one of said pixels to cause said emitters to emit electrons which are attracted to said frame and which collide with gas atoms to produce ions which ions are attracted to said pixel to cause said pixel to emit light.

10. The display of claim 9, wherein said substrate is transparent.

11. The display of claim 9, further comprising a second substrate, oppositely disposed from said substrate, wherein said second substrate is transparent and said light is emitted through said second substrate, said first and second substrates sealed at their peripheries to form an internal hollow.

12. The display of claim 9, wherein said conductive frame comprises a matrix of row and column conductors defining a plurality of cells each associated with one of said pixels.

13. The display of claim 11, wherein a conductive layer (ML) is positioned on the second substrate.

14. A flat panel display comprising: an inert gas, a plurality of associated pixels having a phosphor and a surrounding control frame the pixels having nanotubes disposed thereon; such that if a pixel voltage is negative relative to the frame then a plurality of electrons emitted by the nanotubes are attracted to the frame whereby electrons strike gas atoms in transit to the frame and produce ions and additional electrons; wherein said ions returning to the pixel result in phosphor illumination.

15. The display of claim 14 whereby said ions strike the pixels thus increasing the brightness of a displayed image.

16. The display of claim 1, wherein said gas is a noble gas.

17. A flat panel display comprising: a gas; and a means for disposing nanotubes on a plurality of associated pixels having a phosphor thereon; such that if a pixel voltage is negative relative to the frame then a plurality of electrons emitted by the nanotubes are attracted to the frame whereby electrons strike gas atoms in transit to the frame and produce ions and additional electrons; wherein said ions returning to the pixel result in phosphor illumination.

18. A process for illuminating a phosphor in a flat panel display comprising: disposing nanotubes on a plurality of associated pixels having a phosphor; applying a pixel voltage negative relative to a frame; attracting to the frame a plurality of electrons emitted by the nanotubes; whereby electrons strike atoms of a gas in transit to the frame thereby producing ions and additional electrons; wherein said ions returning to the pixel result in phosphor illumination.

19. A method for increasing the brightness of an image of a flat panel display comprising; disposing nanotubes on each of a plurality of associated pixels; applying a pixel voltage negative relative to a frame; attracting to the frame a plurality of electrons emitted by the nanotubes; whereby electrons strike atoms of an ionizing gas atoms in transit to the frame thereby producing ions and additional electrons; wherein said ions returning to the pixel increasing the brightness of a displayed image.

20. The method according to claim 19 further disposing a phosphor on each of said pixels.
